(19) United States
(12) Patent Application Publication
(10) Pub. No.: US 2009/0132329 A1
(43) Pub. Date: May 21, 2009

(54) Meeting Scheduling to Minimize Inconvenience of Meeting Participants

(75) Inventors: Derek S. Lam, Minneapolis, MN (US); Asima Silva, Holden, MA (US); Ping Wang, Westford, MA (US); Robert C. Weir, Westford, MA (US); Andrew L. Schirmer, Andover, MA (US); Tolga Oral, Winchester, MA (US)

Correspondence Address: CUENOT & FORSYTHE, L.L.C., 20283 State Road 7, Ste. 300, Boca Raton, FL, 33498, US

(73) Assignee: INTERNATIONAL BUSINESS MACHINES CORPORATION, Armork, NY (US)

(21) Appl. No.: 11/942,784

(22) Filed: Nov. 20, 2007

(51) Int. Cl. G06F 17/30

(52) U.S. Cl. 705/9

(57) ABSTRACT

A computer-implemented method of automatically scheduling meetings can include determining that no timeslot is available for scheduling a proposed meeting involving a plurality of participants and selecting a plurality of candidate times for the proposed meeting. An inconvenience metric for each participant of the proposed meeting can be calculated. A schedule misfit metric for each of the plurality of candidate times can be calculated, at least in part, according to the inconvenience metric for each participant. A time for the proposed meeting can be selected from the candidate times according to the schedule misfit metric. The proposed meeting can be scheduled for the selected time.

### FIELD OF THE INVENTION

The embodiments of the present invention relate to automated meeting scheduling and conflict resolution.

### BACKGROUND OF THE INVENTION

Modern calendaring systems allow users to schedule meetings among a plurality of users. Typically, the calendaring system stores, or has access to, a copy of the personal calendar of each user within the system. The calendaring system can facilitate meeting scheduling by searching for blocks of time, e.g., “time slots,” in which each meeting participant is available.

As the number of participants of a meeting increases, the number of time slots in which jointly all participants are available tends to decrease. For example, consider a meeting between “N” participants who, on average, each has “X” percent of his or her time already scheduled. The chance of locating a time slot in which each participant is available can be expressed as (100−X)̂N. The probability of locating a time slot that each participant is available within a 40 hour work week is more remote. This probability can be estimated according to (1−(100−X)̂N)̂40.

As a practical matter, this means that the difficulty of scheduling a meeting between many participants, particularly participants having large portions of unavailable time, is significant. For example, the probability of scheduling a meeting between 10 participants who, on average, have approximately 50% of their time booked is approximately 4%. One can see that the likelihood of scheduling a meeting involving a plurality of participants without displacing one or more other previously scheduled meetings is remote.

### BRIEF SUMMARY OF THE INVENTION

The embodiments disclosed herein relate to automatically scheduling meetings and resolving meeting conflicts. One embodiment of the present invention can include a computer-implemented method of automatically scheduling meetings. The method can include determining that no timeslot is available for scheduling a proposed meeting involving a plurality of participants and selecting a plurality of candidate times for the proposed meeting. An inconvenience metric for each participant of the proposed meeting can be calculated. A schedule misfit metric for each of the plurality of candidate times can be calculated, at least in part, according to the inconvenience metric for each participant. A time for the proposed meeting can be selected from the candidate times to minimize the schedule misfit metric. The proposed meeting can be scheduled for the selected time.

Another embodiment of the present invention can include a computer-implemented method of automatically scheduling meetings. The method can include determining that no timeslot is available for scheduling a proposed meeting involving a plurality of participants and selecting a plurality of candidate times for the proposed meeting. The method can include, for each of the plurality of candidate times, calculating a schedule misfit metric according to an inconvenience metric of each participant of the proposed meeting and an inconvenience metric of each participant of any meeting that conflicts with the candidate time. A time for the proposed meeting can be selected from the candidate times to minimize the schedule misfit metrics. The proposed meeting can be scheduled for the selected time.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 is a block diagram illustrating a system for scheduling a proposed meeting in accordance with one embodiment of the present invention.

FIG. 2 is a graph illustrating a technique for evaluating candidate times for scheduling a proposed meeting in accordance with another embodiment of the present invention.

FIG. 3 is a flow chart illustrating a method of scheduling a proposed meeting in accordance with another embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit,” “module,” or “system.”

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, a magneto-optical disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The embodiments disclosed herein relate to automated scheduling of meetings as well as conflict resolution among meetings. Meetings can be scheduled and rescheduled in a manner that minimizes inconvenience to the parties involved. The embodiments disclosed herein can be implemented as, or as part of, a calendaring system that stores or maintains schedule data for a plurality of different users. Such calendaring systems typically are able to review the schedules of one or more selected users, e.g., participants, to determine whether the participants have a time slot in common during which a proposed meeting can be held.

When attempting to schedule a meeting among a plurality of participants, the calendaring system may determine that no time slot is available during which each participant may attend the meeting. In such cases, a plurality of candidate times for the meeting being scheduled, e.g., the “proposed meeting,” can be evaluated. Since no time slots are available among all participants, each candidate time will have at least one conflicting meeting involving one or more participants of the proposed meeting. As used herein, a “conflicting meeting” may also include any appointment, vacation, other absence or period of unavailability.

Accordingly, candidate times for a proposed meeting can be evaluated in terms of various costs. Each cost either directly or indirectly reflects the cost of scheduling a meeting at a selected candidate time. As each candidate time will have at least one conflicting meeting, the cost of a given candidate time also can reflect the cost or difficulty of rescheduling any meetings that conflict with that candidate time. The costs can be combined to provide an overall cost of for each candidate time. The candidate time having the minimal cost can be selected as the time for the proposed meeting. Any conflicting meetings can be rescheduled using procedures similar to those described.

As used herein, a conflicting meeting can refer to a meeting that, given a particular candidate time, is scheduled to occur during that candidate time or is scheduled to overlap with that candidate time. Further, the conflicting meeting can include one or more users, e.g., participants, that have been designated as participants to a meeting being scheduled, e.g., the proposed meeting, for which the candidate time(s) are being evaluated.

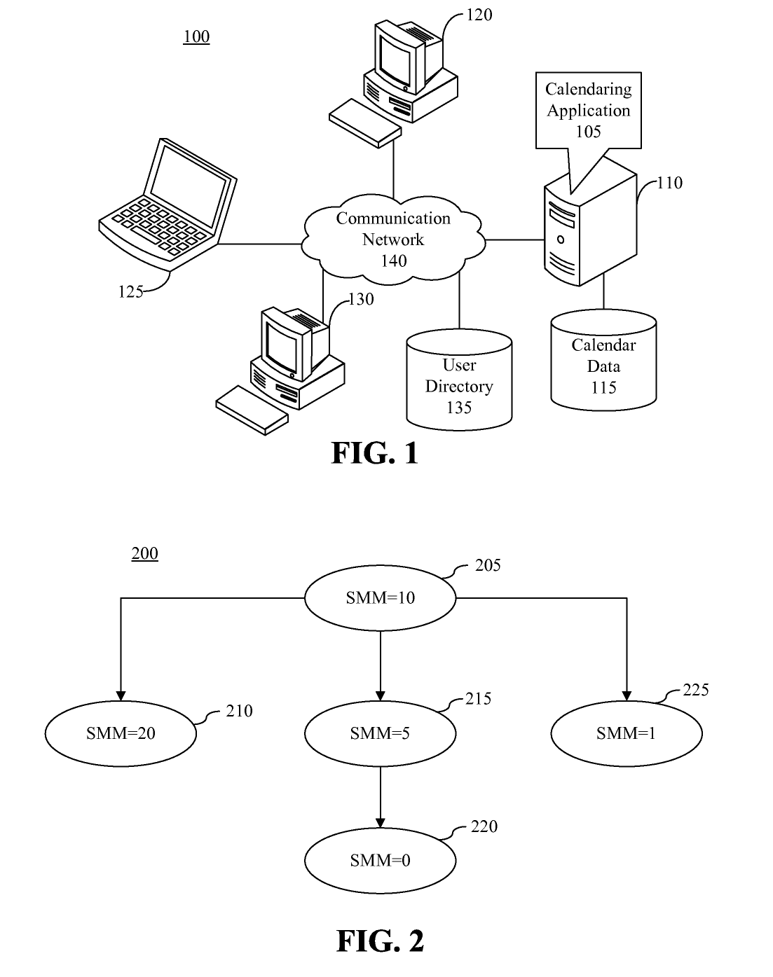

FIG. 1 is a block diagram illustrating a system 100 for scheduling a meeting in accordance with one embodiment of the present invention. As shown, system 100 can include a calendaring application 105 executing within a data processing system 110, a plurality of client data processing systems 120, 125, and 130, as well as a user directory 135. Each of the aforementioned components may be communicatively linked via a communication network 140.

The communication network 140 can be implemented as, or include, without limitation, a WAN, a LAN, the Public Switched Telephone Network (PSTN), the Web, the Internet, and one or more intranets. The communication network 140 further can be implemented as or include one or more wireless networks, whether short or long range. For example, in terms of short range wireless networks, the communication network 140 can include a local wireless network built using a Bluetooth or one of the IEEE 802 wireless communication protocols, e.g., 802.11a/b/g/i, 802.15, 802.16, 802.20, Wi-Fi Protected Access (WPA), or WPA2. In terms of long range wireless networks, the communication network 140 can include a mobile, cellular, and or satellite-based wireless network and support voice, video, text, and/or any combination thereof, e.g., GSM, TDMA, CDMA, and/or WCDMA network.

The data processing system 110 can be a computer system such as server, a desktop computer system, or a combination of several computer systems communicatively linked together via a network. The calendaring application 105 can manage calendar data 115 corresponding to a plurality of users of the calendaring application 105.

The calendar data 115 can specify a schedule for each user that lists meeting dates, times, locations of meetings, resources that have been reserved for use during meetings, and various other attributes to be described herein in greater detail. In one embodiment, meetings from the calendar data 115 can be associated with business objectives and/or deadlines for the business objectives. The business objectives and/or deadlines may be stored with in the calendar data 115 or within another system. Though shown separately from the data processing system 110, the calendar data 115 may be incorporated within the data processing system 110 or exist as a standalone system that may be accessed by the calendaring application 105.

The users of the calendar application 105 may access the calendar data 115 via client applications executing within data processing systems 120, 125, and 130. It should be appreciated that system 100 can support more users than illustrated in FIG. 1 and that the embodiments disclosed herein are not limited by the examples provided. Further, though the calendar data 115 is depicted as being within a separate storage mechanism, the calendar data 115 also may be incorporated within data processing system 110 and/or dispersed within the various data processing systems 120, 125, and/or 130.

The user directory 135 can be implemented, for example, as a Lightweight Directory Access Protocol (LDAP) directory, a database, or the like. The particular manner in which the data is organized or stored may vary. In any case, the user directory 135 can store a profile for each user of the calendaring application 105 indicating information such as the position of each user within the hierarchy of the organization to which the user belongs, e.g., the company, and other preferences. In this regard, the user directory 135 can specify an organizational chart through which distances between positions of different users may be determined.

In operation, a user may begin scheduling a meeting via a calendaring client executing within one of the data processing systems, e.g., data processing system 120. The user can specify a list of participants for the proposed meeting. The calendar application 105 can access the schedule of each participant to determine whether the participants are available for the meeting. If no time slot can be identified for which each participant is available, the calendaring application 105 can begin evaluating candidate times.

In one embodiment, the candidate times that are evaluated can be determined by identifying any business objectives and/or deadlines associated with the meeting to be scheduled and limiting the search space for candidate times to only times prior to the deadline associated with the business objective. It should be appreciated that the business objective and deadline can be automatically identified based upon a programmatic association created between the business objective or deadline and the meeting. Accordingly, a user need not explicitly specify the deadline or time period in which candidate times are to be searched when scheduling the meeting.

The candidate times can be scored according to various cost metrics to be described herein. As at least one candidate time will have at least one conflicting meeting, the cost metrics can be evaluated to determine whether the meeting being scheduled should be scheduled at a selected candidate time, thereby displacing any conflicting meetings. The candidate time having the lowest cost can be selected. Any conflicting meetings can be rescheduled automatically, with notifications being provided to any participants affected by the rescheduled meeting(s).

FIG. 2 is a graph 200 illustrating a technique for evaluating candidate times for scheduling a proposed meeting in accordance with one embodiment of the present invention. FIG. 2 presumes that a meeting is to be scheduled between a plurality of different participants. Further, a free time search by a calendar application has determined that the selected participants of the proposed meeting have no free time in common. That is, there is no time during which the participants can meet while still achieving, or having time to achieve, the purpose of the meeting. For example, the range of time slots that may be checked can be limited to some range, e.g., a week, a month, etc. In another example, the range of time slots can be limited to those occurring within or before a particular deadline that has been associated with a given business objective that is associated with the proposed meeting.

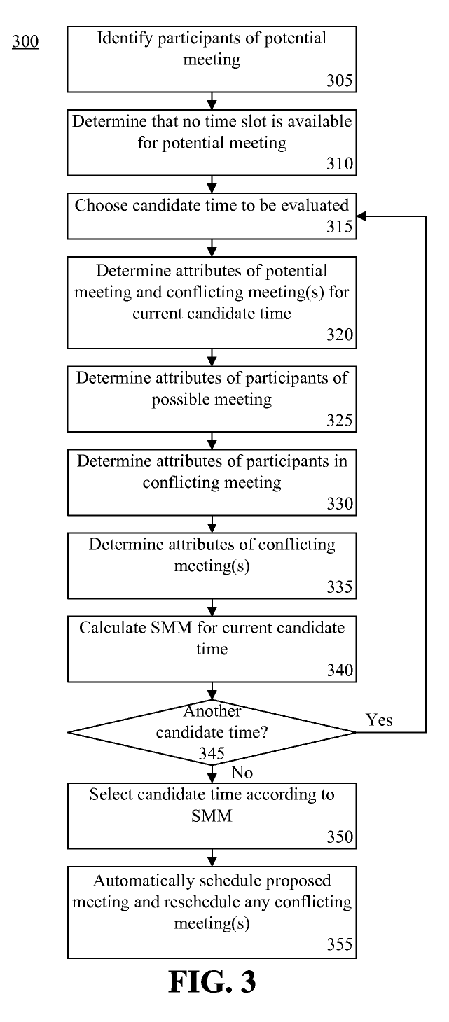

The graph 200 represents the search space for scheduling a proposed meeting. The graph 200 can include a plurality of nodes 205, 210, 215, 220, and 225. Each node represents the joint state of a plurality of user calendars, e.g., a combination of meetings, meeting dates and times, attendees, as well as one or more meeting parameters. The parameters will be described in greater detail with reference to FIG. 3. Each node specifies a different calendar state for the plurality of user calendars. These various states are exploratory, “what-if” states that can be evaluated in order to determine a set of calendar mutations that minimize a cost metric. Such mutations may include meeting reschedules, cancellations, delegation, splitting meetings into two disjoint sessions, reducing the length of a meeting, etc. The root node 205 represents the current state of the calendar and each node directly reachable from root node 205, e.g., nodes 210, 215, and 225, represents a state reachable by a single calendar mutation. Similarly, each node reachable from nodes 210, 215, and 225, namely node 220, represents a state reachable by yet another mutation.

Each of nodes 205-225 can specify a cost that is associated with that state of the calendar. The cost can be referred to as a schedule misfit metric (SMM). The SMM can be calculated from a variety of different costs relating to the inconvenience level of participants if the state of the calendar was as indicated. If there were no conflicts and all desired meetings were accommodated without inconvenience, then the SMM would be zero.

For example, node 205 can represent a state where there is a proposed meeting that does not easily fit into the schedule for a candidate time for a plurality of participants. Since this meeting cannot be scheduled, the calendaring system can determine that the state corresponding to node 205 has an SMM of 10. Since the SMM for node 205 is not zero, the state has a conflict. Nodes 210, 215, and 225 represent states reachable from node 205, for example, by bumping existing meetings and scheduling the proposed meeting in their place.

Each row within graph 200 represents a set of states reached by taking mutually exclusive alternatives. Each path down through the rows represents an accumulation of calendar mutations. For example, in graph 200, node 205 represents the initial state where a new meeting is proposed. To reduce the SMM associated with this state (SMM=10), some other meetings may need to be bumped. Nodes 210, 215, and 225 represent possible states reached for which the meeting associated with node 205 has been accommodated, but the bumped meeting, which now lacks a place in the schedule, determines the SMM.

In the example shown in FIG. 2, if node 210 is selected as the next state, such action will result in an SMM of 20. For example, moving to node 210 from node 205 represents the action of accommodating the original meeting by bumping another meeting that is even more important as indicated by the higher SMM associated with node 210. Thus, moving to state 210 is less desirable than rescheduling the bumped meeting at the candidate time associated with node 225, which has an SMM of 1. Consider, however, that if node 215 is selected as the next state, this causes a conflict with an SMM of 5. This may appear to be a less preferred solution than the state associated with node 225. Going one level deeper, however, one can see that rescheduling the meeting bumped in state 215 to reach state 220 results in an SMM of zero, a solution that is optimal in this example.

When a node with a minimal SMM is found, the path through graph 200 can reveal a set of one or more calendar mutations that are necessary to achieve a meeting time for the proposed meeting with the minimal SMM. These mutations are proposed to the schedule or may be automatically applied. It should be appreciated that graph 200 has been simplified for purpose of illustration and example. In a real-world case, there may be hundreds or thousands of states which would be evaluated. As such, those skilled in the art will appreciate that graph 200 has been presented for purposes of illustration only and is not intended to limit the present invention in any way.

For example, consider trying to schedule a meeting with 10 participants to take place within the next two weeks. Each person has 80 possible hours to evaluate (two weeks times 40 hours). If half of those candidate times are conflicts, one would need to analyze the effect of rescheduling approximately 40 meetings. This in turn may lead to rescheduling another 20 meetings, for example. Accordingly, it may be the case that to schedule a meeting within the next two weeks that involves 10 participants, a tree of approximately 1,400 different nodes, each having an SMM, would need to be evaluated. The path, e.g., or solution, through the tree that gives the lowest total value for SMM may be selected.

By implementing a tree search, any meeting conflicts can be resolved. For example, if a conflicting meeting is to be rescheduled to make room for the proposed meeting, the conflicting meeting can be rescheduled. The conflicting meeting can be rescheduled to a different time slot using the same or a similar technique as described herein.

The graph 200 can be traversed, or searched, using any of a variety of known search algorithms. For example, the minimal SMM value from graph 200 can be determined using breadth first tree traversal, depth first tree traversal, a brute force approach, genetic programming, simulating annealing, dynamic programming, or the like. Optimizations such as “alpha-beta pruning” further may be applied where searching paths that appear to be a worse solution than another path previously evaluated are abandoned rather than completing the path.

FIG. 3 is a flow chart illustrating a method 300 of determining costs for candidate times in accordance with another embodiment of the present invention. The method 300 can be implemented as, or within, a calendaring application executing within a data processing system as described herein. An organizer of a proposed meeting can begin scheduling the meeting. The meeting organizer can specify the meeting participants.

In one embodiment, the method 300 may be utilized in computing SMMs for nodes of a graph representing the joint state of a plurality of user schedules or calendars as discussed with reference to FIG. 2. The embodiments disclosed herein, however, are not limited to one particular type of exploration technique for locating a candidate time and/or set of acceptable meeting parameters for that candidate time.

Accordingly, in step 305, the participants of the proposed meeting can be identified. In step 310, the calendaring application can determine that no time slot is available within which to schedule the meeting. That is, no time slot exists within a designated window of time during which all of the participants identified in step 305 are free to participate. In step 315, a candidate time can be chosen to be evaluated as the time at which the proposed meeting may be scheduled, e.g., the current candidate time.

In step 320, one or more attributes of the proposed meeting and/or any conflicting meetings can be determined. The attributes can relate solely to the proposed meeting, solely to any conflicting meetings, or can be determined through a comparison of the proposed meeting with any conflicting meetings. One attribute that may be evaluated is whether the current candidate time is too late to meet a business objective. Within the calendaring application or another application that is communicatively linked with the calendaring application, a business objective may be defined along with a deadline. If the proposed meeting is associated with the business objective or the deadline, the current candidate time will be given a higher cost the closer the candidate time is to the deadline. Further, if the candidate time is after the deadline, the cost can be made still higher so as to bias the system to consider only those candidate times prior to the deadline.

Another attribute that can be evaluated is the business importance of the proposed meeting and/or any conflicting meeting(s). Business importance can be assigned by the scheduling participant or by an invitee participant. Each participant, for example, may assign a business importance to the proposed meeting or to any conflicting meeting(s). The cost of the candidate time can be determined according to the business importance of the proposed meeting with respect to the business importance of any conflicting meeting(s). For example, if the proposed meeting is more important than the conflicting meeting, the cost of scheduling the proposed meeting at the current candidate time may be lower than had the conflicting meeting had a higher business importance. When determining business importance, it should be appreciated that the individual importance ratings of the participants may be combined or summed to indicate an overall importance for the candidate meeting relative to any conflicting meetings.

Business importance may also be determined through the use of a corporate policy. Such a policy may include one or more rules that may be applied to determine the importance of a meeting. The corporate policy may, for example, override the business importance of a meeting that was initially assigned by a participant. For example, a business policy may indicate that if the subject of a meeting indicates an enumerated topic, the importance should be set to a value of “x.” The subject or content of the meeting can be determined from a subject line or other description of the meeting that is entered into the system by a participant. Techniques such as keyword searching, natural language understanding, or the like may be applied.

Knowledge of whether a meeting will be recorded or memorialized with slides, notes, or other materials also may be considered in determining a cost of a candidate time. For example, if such materials will be available for a conflicting meeting, the cost of the current candidate time will be less than had no materials been available for the conflicting meeting.

Another attribute that may be evaluated is whether any of the conflicting meetings have already been rescheduled at least one time. Any conflicting meetings that have been rescheduled may be given a higher cost. Accordingly, the cost of the candidate time would also be higher than for another candidate time with a conflicting meeting that was not previously rescheduled. This penalty can prevent meetings of seemingly lesser importance from being continually rescheduled.

In step 325, the attributes of participants of the proposed meeting can be determined. These attributes can be used to calculate an inconvenience metric, or cost, for each participant. The inconvenience metric for each participant will be different, or likely different, for each candidate time. The inconvenience metric for each participant of the proposed meeting can be combined, e.g., summed, and included within the larger SMM calculation for the candidate time.

Another attribute that can be evaluated for participants is the role of each participant within the proposed meeting. If the participant is mandatory to the proposed meeting, the inconvenience factor of that participant can be increased or enhanced as compared to the case where the individual is not mandatory, e.g., is an optional attendee. Similarly, whether the participant is a host of the proposed meeting, e.g., the user scheduling the meeting, or a passive attendee can be considered in similar fashion. Any role designated for a proposed meeting may be evaluated in terms of an cost. Each role further may be weighted so that, for example, a moderator, while critical, is not as critical as a presenter in terms of cost.

Another attribute that can be evaluated is a personal rating of past satisfaction or interest in meetings of the type or subject matter of the proposed meeting. A participant with a high personal rating for the proposed meeting will have a higher inconvenience metric when that participant is unable to attend as compared to the participant indicating a lower personal rating. Personal rating also can be used to determine the cost of a conflicting meeting. For example, if the participant scheduled for the conflicting meeting has a high satisfaction level with the conflicting meeting, the inconvenience metric of scheduling the proposed meeting at the current candidate time can be increased. It should be appreciated that the personal rating also may be extended to each participant of the conflicting meeting to obtain a metric that indicates whether all of the participants of the conflicting meeting value that meeting.

Another attribute that may be evaluated is the number of persons that would have to participate in the proposed meeting remotely versus attending in person. For example, a cost penalty can be assessed for the candidate time that increases as the number of persons that are unable to attend the proposed meeting in person increases. Such a cost depends upon whether location for the participants is included in the calendar data.

Another attribute that can be evaluated is the organizational relationship between the scheduling participant of the proposed meeting and an invitee participant of the proposed meeting. For example, each participant that is scheduled for a conflicting meeting can be associated with a cost that may be scaled or adjusted according to the position of that participant within an organizational hierarchy. Thus, the inconvenience metric of a participant that is a manager having a conflict for a candidate time would be higher than the inconvenience metric of a participant that is supervised by the manager. Adjusting costs in this manner effectively assumes that rescheduling persons lower in the organizational hierarchy will be easier than rescheduling persons higher in the hierarchy.

It should be appreciated that cost also may be determined for various participants in more absolute terms in accordance with organizational rank. For example, the cost or SMM of causing inconvenience to a CEO will be higher than for others regardless of the organizational distance. In this manner, costs can be assigned or determined according to rank independently of any consideration of organizational distance with respect to other meeting invitees.

Another attribute that can be evaluated is whether the proposed meeting or any conflicting meetings requires the presence of a participant. The presence of a particular person or representative of a particular department may be necessary for various legal or compliance reasons. For example, if the proposed meeting requires that a human resources person be present, then the inconvenience metric for the human resources participant can be increased if that person has a conflicting meeting. If the human resources person is not required at the proposed meeting, but is required at a conflicting meeting, the inconvenience metric of the human resources person can be increased as well for the current candidate time.

Other attributes that can be evaluated can include the number of persons involved in the meeting and the ability of a participant to delegate meeting attendance to another person. For example, the more participants within a meeting, the higher the cost of rescheduling that meeting. If a participant of the proposed meeting has a conflicting meeting for the current candidate time and the participant is able to send a delegate to either meeting, the inconvenience metric of that participant can be reduced. At that point, the attributes of the delegate, not the original invitee, would be considered when calculating the inconvenience metric.

In step 330, one or more attributes relating to participants of any conflicting meetings for the current candidate time can be evaluated. It should be appreciated, that, as noted above, many of the inconvenience metrics discussed with reference to participants of the proposed meeting can be applied to participants of any conflicting meetings. For example, the various costs can be applied to participants in a conflicting meeting to establish the cost of rescheduling that meeting. This cost can be incorporated into the SMM of the current candidate time. If more than one meeting conflicts with the current candidate time, the analysis can be extended to each participant of each conflicting meeting.

In step 335, one or more attributes relating to any conflicting meetings can be determined and costs can be assessed. For example, if the conflicting meeting is a non-business meeting such as an appointment with a medical doctor, the appointment may be difficult to reschedule. As such, a higher cost metric can be associated with such appointments. In one embodiment, the user associated with the non-business meeting can specify an inconvenience metric indicating the relative degree of difficulty of rescheduling the appointment.

Another attribute that can be evaluated with respect to conflicting meetings is whether a free time slot exists for participants of the conflicting meeting within a predetermined time period of the original date of the conflicting meeting, e.g., the time slot corresponding to the current candidate time being evaluated. For example, if a time slot is available during which the conflicting meeting can be rescheduled within 2, 3, or 4 days of the original date of the conflicting meeting, the cost of rescheduling the conflicting meeting can be lowered, which will lower the cost of the current candidate time. When rescheduling a conflicting meeting, the calendaring application also can be configured to locate or select a time slot that is closest in time to the original time slot for the conflicting meeting.

Another attribute that can be evaluated is whether the conflicting meeting is a special event. For example, in the case where an outside speaker visits, e.g., a person that has come to visit from out of town or is not employed by the organization utilizing the scheduling system, the cost of moving the conflicting meeting can be set high enough so as to avoid any likelihood of rescheduling that meeting.

Another attribute that can be evaluated is the type of meeting. For example, Web conferences and telephone conferences will likely be easier to reschedule than in-person meetings. Conflicting meetings can be assigned a cost metric according to the type of meeting. In some cases, e.g., the case of a Web meeting or a telephone call, the metric may be lower than had the meeting been an in-person meeting. In some cases, the cost of rescheduling the conflicting meeting can be lowered when the conflicting meeting is a Web conference or a teleconference. In other cases, the cost simply can remain the same, e.g., not be increased.

Another attribute that can be evaluated is the cost of rescheduling resources associated with a meeting. For example, any resources such as conference rooms, projectors, telephone conference lines, or other physical resources, can be assigned a cost for rescheduling purposes. If the meeting, e.g., the conflicting meeting, is associated with these items, then the cost of reallocating the items can be added to the cost of the conflicting meeting. In cases where the rescheduling of a meeting causes the resources to be automatically reallocated, e.g., a conference call line, then no cost need be associated with such resources.

Another attribute that can be evaluated is whether the conflicting meeting is a recurring meeting. Recurring meetings can be considered to have a greater cost to reschedule than non-recurring meetings. In one embodiment, the cost of moving a recurring meeting can be increased according to the span of the meeting. For example, if a meeting is recurring over the course of a year, that recurring meeting will likely have a higher cost for rescheduling than a meeting that is recurring over several months.

Another attribute that can be evaluated is the interaction of various tasks, to-do's, deadlines, agenda items, and the like that may be defined within a project management system, personal information management system, or the like. For example, a meeting associated with a business objective having a deadline and/or one or more agenda items, may have a higher cost to reschedule than a meeting that does not. Such meetings may be viewed as being more important or essential and less informal than meetings without such preparatory materials or associated goals.

In step 340, the SMM for the candidate time can be determined. The SMM can be calculated using one or more or all of the various costs described herein. For example, the cost of the current candidate time can be determined by summing the various costs and/or other metrics. In another example, different ones of the costs can be weighted so as to accord more importance to the weighted costs thereby biasing the scheduling system.

In step 345, a determination can be made as to whether any further candidate times are to be evaluated. The calendaring system can be configured to search for time slots within a specified period of time, e.g., a window of time. The time slots may occur each hour, half hour, quarter hour, etc. In one embodiment the window of candidate times to be evaluated can be a user specified window. In another embodiment, the window can be determined according to business objectives, milestones, or other deadlines that may be programmed into the system or otherwise associated with the proposed meeting. Accordingly, the calendaring application can identify such deadlines and define the window to not extend beyond any relevant dates or deadlines associated with the proposed meeting. If further candidate times remain to be evaluated, the method can loop back to step 315 to select a next candidate time for evaluation. If not, the method can proceed to step 350.

In step 350, a candidate time can be selected. In step 355, the proposed meeting time can be scheduled automatically. Further, any conflicting meetings can be rescheduled automatically. In scheduling the proposed meeting, a meeting entry can be placed within the schedule of each participant. Participants may be notified of the scheduled proposed meeting and participants of any conflicting meetings may be notified of an impending change as well as the new meeting time of the conflicting meeting(s) after rescheduling. In another embodiment, the selected candidate time can be output. As used herein, “output” or “outputting” can include, but is not limited to, writing to a file, writing to a user display or other output device, playing audible notifications, sending or transmitting to another system, exporting, or the like.

The selected time can be one that has a minimum SMM as calculated from the costs discussed herein. Once a candidate time is selected, any displaced conflicting meeting(s) can be rescheduled. The conflicting meeting(s) can be rescheduled by iteratively applying the method as described with reference to FIG. 3. This can be performed for each conflicting meeting that is displaced by scheduling the proposed meeting at the selected candidate time.

The flowchart(s) and block diagram(s) in the figures illustrate the architecture, functionality, and operation of possible implementations of systems, methods and computer program products according to various embodiments of the present invention. In this regard, each block in the flowchart(s) or block diagram(s) may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram(s) and/or flowchart illustration(s), and combinations of blocks in the block diagram(s) and/or flowchart illustration(s), can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A computer-implemented method of automatically scheduling meetings comprising:
determining that no timeslot is available for scheduling a proposed meeting involving a plurality of participants;
selecting a plurality of candidate times for the proposed meeting;
calculating an inconvenience metric for each participant of the proposed meeting for each candidate time;
calculating a schedule misfit metric for each of the plurality of candidate times, at least in part, according to the inconvenience metric for each participant;
selecting a time for the proposed meeting from the candidate times to minimize the schedule misfit metrics; and
scheduling the proposed meeting for the selected time.

2. The computer-implemented method of claim 1, wherein selecting a plurality of candidate times comprises:
identifying a business objective associated with the proposed meeting;
identifying a deadline of the business objective; and
determining a period of time from which the candidate times are selected according to the deadline associated with the business objective.

3. The computer-implemented method of claim 1, wherein calculating a schedule misfit metric comprises adjusting the inconvenience metric for each participant according to a user-specified level of interest for the participant relative to a meeting that conflicts with the candidate time.

4. The computer-implemented method of claim 1, further comprising, for each participant, adjusting the inconvenience metric for the candidate time according to an organizational position of the participant.

5. The computer-implemented method of claim 1, wherein calculating a schedule misfit metric further comprises reducing the schedule misfit metric for a selected candidate time when at least one participant is permitted to delegate attendance to another individual for the proposed meeting at the selected candidate time.

6. The computer-implemented method of claim 1, further comprising adjusting the schedule misfit metric for each candidate time according to an organizational distance between a participant identified as an invitee participant and a participant identified as a scheduling participant.

7. The computer-implemented method of claim 1, wherein calculating a schedule misfit metric further comprises, for each candidate time:
identifying meetings that conflict with the candidate time;
determining a schedule misfit metric for each conflicting meeting; and
adding the schedule misfit metric for each conflicting meeting to the schedule misfit metric of the candidate time.

8. The computer-implemented method of claim 7, wherein calculating a schedule misfit metric comprises adjusting the schedule misfit metric for each candidate time according to whether each conflicting meeting for the candidate time is a recurring meeting and a period of time over which the conflicting meeting recurs.

9. The computer-implemented method of claim 7, wherein determining a schedule misfit metric for each conflicting meeting comprises:
identifying participants of each conflicting meeting;
calculating an inconvenience metric for each participant of the conflicting meetings; and
summing the inconvenience metrics of each participant associated with the conflicting meetings for the candidate time.

10. The computer-implemented method of claim 1, wherein calculating a schedule misfit metric comprises adjusting the schedule misfit metric for a selected candidate time according to a number of participants that would participate in the proposed meeting remotely.

11. The computer-implemented method of claim 1, wherein calculating a schedule misfit metric comprises adjusting the schedule misfit metric for a selected candidate time according to whether a meeting agenda has been associated with a meeting that conflicts with the selected candidate time.

12. A computer-implemented method of automatically scheduling meetings comprising:
determining that no timeslot is available for scheduling a proposed meeting involving a plurality of participants;
selecting a plurality of candidate times for the proposed meeting;
for each of the plurality of candidate times, calculating a schedule misfit metric according to an inconvenience metric of each participant of the proposed meeting and an inconvenience metric of each participant of any meeting that conflicts with the candidate time;
selecting a time for the proposed meeting from the candidate times to minimize the schedule misfit metrics; and
scheduling the proposed meeting for the selected time.

13. The computer-implemented method of claim 12, wherein calculating a schedule misfit metric further comprises reducing the schedule misfit metric for a selected candidate time when at least one participant is permitted to delegate attendance to another individual for the proposed meeting at the selected candidate time.

14. The computer-implemented method of claim 12, wherein calculating a schedule misfit metric further comprises increasing the schedule misfit metric of any meeting involving at least two participants from different organizations.

15. The computer-implemented method of claim 12, wherein calculating a schedule misfit metric further comprises increasing the schedule misfit metric of any meeting that has been rescheduled at least one time.

16. The computer-implemented method of claim 12, wherein calculating a schedule misfit metric further comprises, for any conflicting meeting, decreasing the schedule misfit metric when the conflicting meeting can be rescheduled within a predetermined amount of time of an original time for the conflicting meeting.

17. A computer program product comprising:
a computer-usable medium comprising computer-usable program code that automatically schedules meetings, the computer-usable medium comprising:
computer-usable program code that determines that no timeslot is available for scheduling a proposed meeting involving a plurality of participants;
computer-usable program code that selects a plurality of candidate times for the proposed meeting;
computer-usable program code that calculates an inconvenience metric for each participant of the proposed meeting for each candidate time;
computer-usable program code that calculates a schedule misfit metric for each of the plurality of candidate times, at least in part, according to the inconvenience metric for each participant;
computer-usable program code that selects a time for the proposed meeting from the candidate times according to the schedule misfit metrics; and
computer-usable program code that schedules the proposed meeting for the selected time.

18. The computer program product of claim 17, wherein the computer-usable program code that selects a plurality of candidate times further comprises:
computer-usable program code that identifies a business objective associated with the proposed meeting;
computer-usable program code that identifies a deadline of the business objective; and
computer-usable program code that determines a period of time from which the candidate times are selected according to the deadline associated with the business objective.

19. The computer program product of claim 17, wherein the computer-usable program code that calculates a schedule misfit metric further comprises, for each candidate time:
computer-usable program code that identifies meetings that conflict with the candidate time;
computer-usable program code that determines a schedule misfit metric for each conflicting meeting; and
computer-usable program code that adds the schedule misfit metric for each conflicting meeting to the schedule misfit metric of the candidate time.

20. The computer program product of claim 19, wherein the computer-usable program code that determines a schedule misfit metric for each conflicting meeting comprises:
computer-usable program code that identifies participants of each conflicting meeting;
computer-usable program code that calculates an inconvenience metric for each participant of a conflicting meeting; and
computer-usable program code that sums the inconvenience metrics of each participant associated with the conflicting meetings for the candidate time.
